(19) United States
(12) Patent Application Publication
(10) Pub. No.: US 2009/0150277 A1
(43) Pub. Date: Jun. 11, 2009

(54) Automated Trading System with Position Keeping

(75) Inventor: Lars-Goran Larsson, Vallentuna (SE)

Correspondence Address: POTOMAC PATENT GROUP PLLC, P. O. BOX 270, FREDERICKSBURG, VA, 22404, US

(73) Assignee: Cinnober Financial Technology AB, Stockholm (SE)

(21) Appl. No.: 11/951,512

(22) Filed: Dec. 6, 2007

(51) Int. Cl. G06Q 40/00

(52) U.S. Cl. 705/37

(57) ABSTRACT

In a method and a system for executing automated matching of financial instruments, an order book of the automated trading system in which orders are placed is interconnected with a position-keeping system or module. This is done in a way such that a controlling unit connected to both the order book and the position-keeping system can cancel orders in the order book, if, when an order is traded, insufficient collateral remains for any remaining order in the order book to be covered if traded. The methods and systems can advantageously be used in automated trading systems having a central counterpart.

### BACKGROUND

The present invention relates to a method and a system for trading financial instruments.

In a financial market, more or less all trading activities involve some levels of risk that must be monitored. The risk can be, e.g., counterparty risk, market risk, or currency risk. In bilateral trading, the exposure to different counterparts is of particular interest. In a market with central clearing services, the general exposure of all participants needs to be handled.

A known problem in a financial market is to define the actual amount of collateral that needs to be provided in order to cover a particular risk exposure. Hence, ideally, the required amount should be sufficient to guarantee a transaction, but not higher than actually needed. A reason for not posting more collateral is that this will have negative impact on the possibilities for market participants to feed liquidity to the market.

Furthermore, different markets apply different rules for calculating risk and determining the amount to be covered by the collateral. In bilateral trading, this is defined by bilateral agreements between the participants. In exchange trading, this is defined in general agreements between the exchange and its participants. Once defined, the risk always needs to be covered in order to enable trading activities to proceed. Risk is usually defined by the use of different mathematical algorithms and often involves parameters that are sensitive to market and environmental movements. Risk can typically be covered by pledging assets and securities as collateral between counterparts. In addition, credit limits issued between the counterparts, or between a central clearing entity and the participants, are also common. In case of a default situation, the collateral provided by the defaulting party can be transferred to the counterpart as a fulfillment of the agreements between the defaulting party and its counterpart.

In a trading environment, the risk involved is usually maintained on a position basis. This is typically the case when instruments are kept as positions over a period of time, e.g., derivatives instruments.

Positions are aggregated trades. Trades are agreements between the buyer and the seller. Every new trade leads to an update of the position. When the risk involved in the position has changed, it can be recalculated. There are a number of different existing algorithms in use around the world for this purpose. In multilateral clearing environments, algorithms such as SPAN and TIMS are well-recognized. In bilateral trading, other algorithms may be required. At most derivatives exchanges, this position-based risk is often calculated on a daily basis. It can also be calculated several times a day.

It is relevant to focus on the risk exposed by the positions taken, as well as the risk exposed by a submitted order in an order book. Therefore, in some trading systems, the risk is calculated and verified against the collateral on an order-by-order basis. That is, in the existing system, every time a trader enters an order to buy or sell an instrument, the risk involved in that potential trade has to be covered.

For example, when submitting an order to buy in the stock market, the customer may have to provide the assumed settlement amount, in case the order trades. Thus, if an order to buy 1,000 shares limited at 5 dollars each is submitted to a trading system, the system can be adapted to check if the trading entity has pledged a sufficient amount of collateral for covering that risk. If the collateral is sufficient, the order is submitted into the system; else it is rejected.

One delicate task for a system that calculates risk and requirements is to estimate the required amount of collateral. On the one hand, it is of interest to provide a system that is enabled to demand an amount that is not too big, because that would reduce the liquidity in the market. On the other hand, the system should not demand an amount too small, because, if the trading party is in default, there will not be enough collateral with which to compensate the counterparty. In addition, the system used to determine if sufficient collateral is posted to accept a particular order should also take into account market movements of underlying securities, currency, and other instruments. Such parameters must be determined adequately.

Hence, there exists a need for a method and a system that enables an automated trading system to accurately determine which orders to accept and which to reject, so that as many orders as possible are accepted. This strategy will generate high liquidity and, at the same time, only accept orders with which a sufficient amount of collateral is associated.

### SUMMARY

It is an object of the present invention to overcome or at least reduce some of the problems associated with existing automated trading systems involving the posting of collateral.

It is another object of the present invention to provide a method and a system that is capable of increasing the liquidity in a market, while reducing the risk that a defaulting party has not posted enough collateral.

It is yet another object of the present invention to provide a method and a system that increases the flexibility for a trader to trade within the limits given by the amount of collateral posted.

These objects and others are obtained by a method, a system, and a computer program, as set out in the appended claims. Thus, the order book of an automated trading system in which orders are placed is interconnected with a position-keeping system or module. This is done in such a way that, the controlling unit connected to both the order book and the position-keeping system can cancel orders in the order book, if when an order is traded insufficient collateral remains for any remaining order in the order book to be covered if traded. The system can advantageously be used in an automated trading system that has a central counterpart.

In such a system, the control unit only needs to check if a submitted order is covered, and needs not take into account orders in the order book not yet traded. In other words a trader can have multiple orders pending in the order book, which together would exceed the limit given by the posted collateral. But since the order book and the position-keeping system are interconnected, the system—in one configuration—is enabled to automatically cancel an order in the order book if another order is traded, if the result of the traded order is that the remaining order in the order book is not covered by the posted collateral. As a result, a trader can submit as many orders as s/he wishes, as long as each individual order does not exceed the currently posted collateral and/or credit limit. The trader knows that some orders may be cancelled if one or more orders trade.

In accordance with another embodiment, a remaining order in the order book is not cancelled if such a remaining order in the order book is not covered by the posted collateral. Instead, it is reduced in size so that the reduced order is within the limits of the remaining posted collateral.

Using the method and system in accordance with the present invention will provide an automated trading system which is proactive in the sense that new orders are validated as potential trades. And the effect that each of them would have on the risk exposure is calculated for the position. Still the system allows the trader to put in a number of orders such that, if they all trade, the risk exposure would exceed the collateral provided, as long as none of the orders will individually exceed the collateral provided.

### BRIEF DESCRIPTION OF THE DRAWINGS

The present invention will now be described in more detail by way of non-limiting examples and with reference to the accompanying drawings, in which:

FIG. 1 is a view of an automated trading system comprising a synchronized order book and position-keeping module, and

FIG. 2 is a flowchart illustrating steps performed when trading orders in an automated trading system.

### DETAILED DESCRIPTION

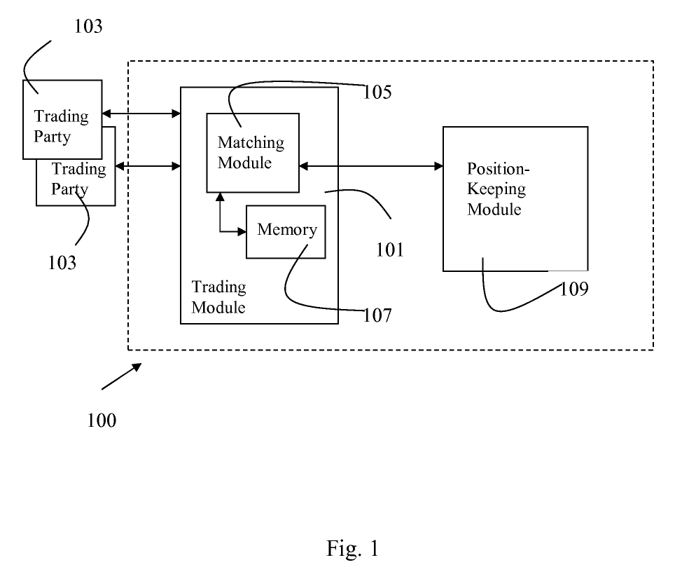

In FIG. 1, a view illustrating an automated trading system 100 is shown. The automated trading system 100 comprises a trading module 101 for receiving orders from various trading parties 103, such as banks, brokers, and individual traders, connected to the automated trading system 100 for placing orders therein. The trading module 101 of the system 100 has a matching module 105, which acts as a controller unit and matches incoming orders. The trading module 101 also has a memory 107, arranged as an order book, where orders not immediately matched can be stored if the order is of a type allowing the order to be placed in the order book if not matched directly. In addition, the system 100 is connected to a position-keeping module 109. The position-keeping module can be integrated into the system 100 or be separate from it. However, the position-keeping module 109 is in real-time connection with the order book 107, which is controlled by the matching module 105.

Furthermore, the position-keeping module keeps track of all executed trades and all collateral posted by each trading party trading at the automated trading system 100. Because the matching module 105 is interconnected with the position-keeping module 109, a trade executed by the matching module 105 can, in real time, update the positions for the parties involved in the trade. As a result, there may be orders in the order book that are outside the limits of posted collateral in the order for one or more of the parties involved in the trade.

For example, consider the example given above when submitting an order to buy in the stock market. Thus, if an order to buy 1,000 shares limited at five dollars each is submitted to a trading system, the system can be adapted to check if the trading entity has pledged a sufficient amount as collateral for covering that risk. If the collateral is deemed sufficient as determined by some algorithm, the order is submitted into the system; else it is rejected.

If the same trader succeeds in submitting the first order, and wants to submit another order to buy 1,000 shares at four dollars each, it would require an additional $4,000 plus commission to ensure the payment. Even though the trader may be equally willing to trade one of the orders and cancel the other order, s/he will still have to present full collateral to ensure payments as if both orders would trade in a conventional system.

In accordance with the present invention it is no longer necessary to impose such a restriction. Instead, as long as each individual order is covered by the posted collateral, an order can be submitted to the system. However, once an order has been traded, a remaining order may be wholly or partially cancelled to fit within the limits of the remaining posted collateral and/or credit limit.

Below is an example from the equity options market. Please note that the same mechanism may be applied to any kind of a market where order books and position-keeping are interconnected, and where orders in the order book can be synchronized with the positions for a particular trading entity.

Assume a trader with the following derivatives position in IBM:

| IBM | Expiry | Strike | Long | Short |
|---|---|---|---|---|
| Call Option | 19-Mar-2008 | 115 | 50 | |
| Call Option | 19-Mar-2008 | 120 | | 30 |
| Put Option | 18-Jun-2008 | 110 | 40 | |
| Put Option | 18-Jun-2008 | 100 | | 25 |
| Future | 18-Jun-2008 | | 10 | |

This position requires a margin of X dollars to cover the risk. Assume this amount is covered by the current collateral and/or credit limit.

Next the trader submits a first order: a new bid order of 10 lots in the IBM Put Option 18-Jun-2008 100 strike. The system 100 calculates the risk if the submitted order were to trade, as well as the impact it would have on the position. That is, the calculation is based on the following imaginary position:

| IBM | Expiry | Strike | Long | Short |
|---|---|---|---|---|
| Call Option | 19-Mar-2008 | 115 | 50 | |
| Call Option | 19-Mar-2008 | 120 | | 30 |
| Put Option | 18-Jun-2008 | 110 | 40 | |
| Put Option | 18-Jun-2008 | 100 | 10 | 25 |
| Future | 18-Jun-2008 | | 10 | |

This new imaginary position will require Y dollars for covering the risk. If this amount is less than the collateral and/or credit limit, then the order is accepted; if not, then the order is rejected.

Assume that the first order is accepted and placed in the order book.

The trader now wants to submit a second order, an order to sell into the system. It is 10 lots in the IBM Call Option 19-Mar-2008 115 strike. The system calculates the risk as if this second order were to trade, as well as the impact that would have on the position. Please note that the first order placed in the order book is not part of the equation when the risk is calculated:

| IBM | Expiry | Strike | Long | Short |
|---|---|---|---|---|
| Call Option | 19-Mar-2008 | 115 | 50 | 10 |
| Call Option | 19-Mar-2008 | 120 | | 30 |
| Put Option | 18-Jun-2008 | 110 | 40 | |
| Put Option | 18-Jun-2008 | 100 | | 25 |
| Future | 18-Jun-2008 | | 10 | |

This new imaginary position will require Z dollars for covering the risk. If this amount is less than the collateral and/or credit limit, then the order is accepted; if not, then the order is rejected.

The collateral and/or credit limit is preferably set to cover the largest of the amount: X, Y, and Z.

Next assume that the first order trades. The position is then as follows:

| IBM | Expiry | Strike | Long | Short |
|---|---|---|---|---|
| Call Option | 19-Mar-2008 | 115 | 50 | |
| Call Option | 19-Mar-2008 | 120 | | 30 |
| Put Option | 18-Jun-2008 | 110 | 40 | |
| Put Option | 18-Jun-2008 | 100 | 10 | 25 |
| Future | 18-Jun-2008 | | 10 | |

The collateral must now cover Y dollars. That validation was made upon entry of the first order.

The risk for each outstanding order now has to be recalculated. Each order that contributes to the position with a calculated risk exposure less than the collateral and/or credit limit is accepted; if not, then the order is rejected and wholly or partially cancelled. Also, every time an order is cancelled or modified, a new check is preferably made.

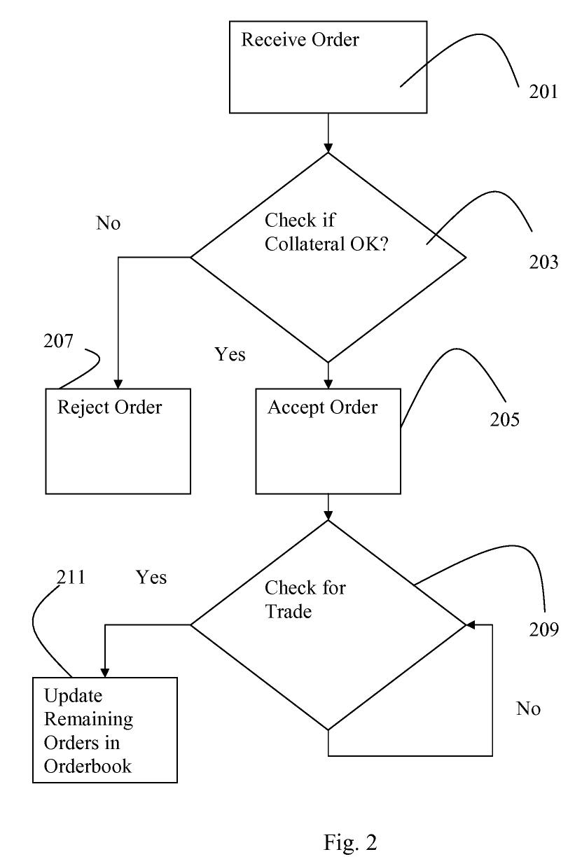

In FIG. 2 is shown a flowchart illustrating different steps performed in an automated trading system, such as the system 100. First, in step 201, a new order is received by the system. Next, in step 203, the system checks whether the received order is covered by the current collateral and/or credit limit. The check in step 203 can, for example, be performed by calculating and validating the received order against existing the current collateral and/or credit limit. If, in step 203, it is determined that the order is covered by the current collateral and/or credit limit, the order is accepted in step 205. Else, if in step 203, it is determined that the order is not covered by the collateral and/or credit limit, the order is rejected in step 207.

In step 209, the system continuously checks if the order accepted in step 205 is traded. If the accepted order is traded, i.e., a match occurs, the system updates the position of the trading party. And the system checks whether all other orders in the order book of the same trading party are still within the collateral and/or credit limit after the order has been traded. In one configuration of the trading system, if, during the check in step 209, it is revealed that an order is no longer covered, that order is cancelled wholly or partially in step 211. In another configuration, an order that is not covered after another order has been traded is reduced in size so that it is covered.

The method and system described here will provide an automated trading system that validates new submitted orders as potential trades, but not completed trades. As is readily understood, the method and system can advantageously be computer-implemented by means of a hardware configuration loaded with suitable computer software. This allows a trader to put in a number of orders in such a way that, if all were to trade, the risk exposure would exceed the collateral provided, even though none of the individual orders individually would exceed the collateral provided. This increases the flexibility of the automated trading system and provides traders with more strategy options, which, in turn, is likely to increase the liquidity in the market.

This invention can be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any device that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

What is claimed is:

1. An automated trading system, comprising an order-matching module for matching orders received by the automated trading system from trading parties connected to the automated trading system, an order book for storing orders submitted to the system that are not immediately matched, and a position-keeping module keeping the position for trading parties; the position-keeping module being interconnected with the order book; the system being configured to accept an order submitted from a trading party if the order, if traded, is covered by a current collateral and/or credit limit associated with that trading party.

2. The system of claim 1, wherein the system is configured to check that all remaining orders in the order book associated with a particular trading party are within the current collateral and/or credit limit associated with that trading party.

3. The system of claim 2, wherein the system is configured to cancel all orders not covered by the current collateral and/or credit limit associated with that trading party.

4. The system of claim 2, whereby the system is configured to partially or wholly cancel all orders not covered by the current collateral and/or credit limit associated with that trading party, such that all remaining orders are within the current collateral and/or credit limit associated with that trading party.

5. The system of claim 1, wherein the system is configured to act as a central counterpart for the respective trading parties.

6. A method in an automated trading system, the trading system comprising an order-matching module for matching orders received by the automated trading system from trading parties connected to the automated trading system, an order book for storing orders submitted to the system that are not immediately matched, and a position-keeping module keeping the position for trading parties, the position-keeping module being interconnected with the order book, the method comprising the step of:
accepting an order submitted from a trading party, if the order, if traded, is covered by a current collateral and/or credit limit associated with that trading party.

7. The method of claim 6, further comprising the step of:
checking that all remaining orders in the order book associated with a particular trading party are within the current credit limit and/or collateral associated with that trading party.

8. The method of claim 7, further comprising the step of:
cancelling all orders not covered by the current credit limit and/or collateral associated with that trading party.

9. The method of claim 7, further comprising the step of:
partially or wholly cancelling all orders not covered by the current credit limit and/or collateral associated with that trading party, such that all remaining orders are within the current credit limit and/or collateral associated with that trading party.

10. The method of claim 6, wherein the system is configured to act as a central counterpart for the respective trading parties.

11. A computer-readable medium encoded with a computer program for an automated trading system including an order-matching module for matching orders received by the automated trading system from trading parties connected to the automated trading system, an order book for storing orders submitted to the system that are not immediately matched, and a position-keeping module keeping the position for trading parties, the position-keeping module being interconnected with the order book, wherein the computer program when executed causes the computer to perform at least the step of:
accepting an order submitted from a trading party, if the order, if traded, is covered by a current collateral and/or credit limit associated with that trading party.

12. The medium of claim 11, wherein the computer program when executed causes the computer to perform at least the further step of:
checking that all remaining orders in the order book associated with a particular trading party are within the current credit limit and/or collateral associated with that trading party.

13. The medium of claim 12, wherein the computer program when executed causes the computer to perform at least the further step of:
cancelling all orders not covered by the current credit limit and/or collateral associated with that trading party.

14. The medium of claim 12, wherein the computer program when executed causes the computer to perform at least the further step of:
partially or wholly cancelling all orders not covered by the current credit limit and/or collateral associated with that trading party, such that all remaining orders are within the current credit limit and/or collateral associated with that trading party.

15. The medium of claim 11, wherein the automated trading system is configured to act as a central counterpart for the respective trading parties.
